(19) United States
(12) Patent Application Publication
(10) Pub. No.: US 2013/0250273 A1
(43) Pub. Date: Sep. 26, 2013

(54) Threshold Detection Method and Device for LIDAR Time of Flight System Using Differentiated Gaussian Signal

(71) Applicant: David Ludwig, Irvine, CA (US)

(72) Inventor: David Ludwig, Irvine, CA (US)

(73) Assignee: ISC8 Inc., Costa Mesa, CA (US)

(21) Appl. No.: 13/425,535

(22) Filed: Mar. 21, 2012

(51) Int. Cl. G01C 3/08

(52) U.S. Cl. 356/4.07

(57) ABSTRACT

A LIDAR device and method for determining the range of a target surface using a threshold detector circuit that differentiates the laser return signal to define a differentiated signal. The signal level crossing point or threshold is representative of the peak amplitude of the return signal. The device and method compare the signal level crossing point to a predetermined threshold level to determine the range of the target surface in a LIDAR system.

### CROSS-REFERENCE TO RELATED APPLICATIONS

N/A

### STATEMENT REGARDING FEDERALLY SPONSORED RESEARCH AND DEVELOPMENT

N/A

### BACKGROUND OF THE INVENTION

1. Field of the Invention

The invention relates generally to the field of electronic circuits.

More specifically, the invention relates to threshold detection or comparator circuitry and a method for detecting a predetermined signal level crossing of a Gaussian-like electrical signal or pulse such as a return echo signal received by a LIDAR time-of-flight (“TOF”) system.

2. Description of the Related Art

In general, existing LIDAR systems comprise a laser imaging source, appropriate optics operating in conjunction with a photo-detector array, signal processing circuitry suitable for processing the photo-detector array output into a usable form and post-processing circuitry and software capable of taking the processed photo-detector array output and converting it into a usable format such as an image on an electronic display.

Existing time of flight LIDAR imaging methods typically comprise scanning a target with a laser source and detecting the reflected photons (also referred to as a laser echo or return) with a photo-detector element such as a photo-detector focal plane array. The time required for the return of the laser echo from the target surface to the photo-detector array is calculated and used to determine the target range. The photo-detector output signal generated in response to the laser return echo is electronically processed to define target surface features on three-dimensional target objects.

LIDAR imaging capability is valuable in situations where, for instance, a vehicle is camouflaged or obscured by foliage or in an urban environment when an imaging sensor can acquire only a limited or angular view of a target.

Because the time of flight of the returning laser echoes varies based on the distance between the photo-detector array plane and the target surface features from which the echoes are received, a three-dimensional image can be calculated based upon the relative echo delays.

Given the speed of light, a laser echo delay of one nanosecond indicates a target surface variation of about 15 centimeters and a laser echo delay of 500 picoseconds translates into a target surface variation of about eight centimeters. As is evident from these short time periods, very high detector signal processing and timing circuit speeds are necessary to resolve target surface feature variations at a centimeter-level depth resolution. Unfortunately, existing LIDAR imaging systems lack the necessary circuit speed and capacity to achieve very high (i.e., centimeter or less) range resolution and sensitivity.

A need thus exists for a LIDAR imaging system that has the circuitry speed and density to achieve range resolution and sensitivity for defining small target surface variations based on picosecond time of flight differences in laser echoes.

The instant invention addresses the aforementioned deficiencies in prior art time of flight LIDAR devices by providing a reliable, high speed, high circuit density LIDAR detector system and device capable of providing range resolution and sensitivity at a sub-centimeter level.

### BRIEF SUMMARY OF THE INVENTION

The present invention may comprise an electromagnetic imaging or illumination source, such as a laser, beam-shaping optics to shape the imaging beam to a predetermined shape, a two-dimensional photo-detector array comprised of multiple photo-detector pixels, an optical lens for collecting reflected photons (i.e., a laser echo) upon the detector array, a processing module comprised of a plurality stacked layers of readout electronics integrated circuit chips (ROIC), wherein each ROIC-containing layer has one or more channels, each channel containing circuitry for processing the photo-detector array signals.

The ROIC may comprise a threshold detector circuit for differentiating the return signal to define a differentiated signal having a signal level crossing point representative of the peak amplitude of the return signal, and for comparing the signal level crossing point to a predetermined threshold level to determine the range of the target surface. The invention may comprise external support circuitry for generating a three-dimensional target image on an electronic display from the output of the processing module.

In a first aspect of the invention, a LIDAR photo-detector module is provided comprising a photo-detector array comprising a plurality of photo-detectors for detecting photons and generating output signals in response to the photon detection, a plurality of readout electronics integrated circuit chips, each of the readout electronics integrated circuit chips comprising a plurality of channels for receiving and processing the output signals generated by the photo-detector array wherein the plurality of readout electronics integrated circuit chips are arranged in a stacked configuration wherein said photo-detector array is bonded to a lateral surface of the stacked configuration perpendicular to the stacked configuration and connected to the plurality of channels via a plurality of connections arranged on the lateral surface of the stacked configuration.

At least one of the readout integrated circuit chips comprises threshold detection differentiating circuit means configured to output a differentiated signal having a signal level crossing point representative of the peak amplitude of a laser echo or return signal.

In a second aspect of the invention, the received signal may be a sine function, Gaussian or Gaussian-like signal which may include a flat-top Gaussian, or a 2D Bessel function, or an irregular pulse like a Gaussian with noise, all collectively referred to herein as Gaussian signals.

In a third aspect of the invention, the received signal is differentiated using high pass filter circuitry means.

In a fourth aspect of the invention, a method for determining the range of a target surface is provided comprising the steps of imaging the target surface with an electromagnetic illumination signal, receiving a reflected echo of the illumination signal as a return signal having a peak amplitude, differentiating the return signal to define a differentiated signal having a signal level crossing point representative of the peak amplitude and comparing the signal level crossing point to a predetermined threshold level to determine the range of the target surface.

In a fifth aspect of the invention, the return signal in the method is a Gaussian signal.

In a sixth aspect of the invention, the return signal in the method is differentiated using high pass filter circuitry means.

The enhanced imaging capability provided by the claimed invention is achieved, in part, by the use of stacked layers containing the ROIC circuitry, which increases photo-detector output processing circuit density while minimizing circuit lead length and associated capacitance. The result of the stacked layers of ROIC circuitry is the ability to integrate a large (e.g., 128×128 or larger) photo-detector array with associated dedicated photo-detector readout circuitry (amplifier, threshold detector, sampling circuitry, digital-to-analog converter (DAC) and first in, first out, (FIFO) register range bins all within a very small module.

The resultant module permits circuit speeds and densities required to resolve small, three-dimensional target features based on one or more laser echoes sensed by each photo-detector pixel on the detector array while simultaneously providing dedicated processing channels for each photo-detector on the detector array.

The multilayer ROIC processing module is preferably comprised of a stack of layers containing thinned, integrated circuit chips, each layer including one or more receiver channels. Each channel comprises circuitry which detects the laser echo time from T₀ (the start of a laser pulse or a user-assigned T₀ point) to the time of laser echo return, based on the receipt of photons that are reflected from the imaged target surfaces. Laser echo time of flight information is pre-processed, and then converted to a digital bit stored in a FIFO register comprising a set of range bins on the ROIC. A high bit in a range bin may, for instance, be designated as indicating the time of arrival of a laser echo, based on its location within the set of range bins. The range bin data is multiplexed off of the ROIC module to external circuitry which, in turn, interprets the data and converts it to a usable form, such as a 3-D point cloud for representation as an electronic image on a display.

While the claimed apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

### BRIEF DESCRIPTION OF THE DRAWINGS

FIGS. 1A, 1B and 1C show a prior art read out integrated circuit chip (“ROIC”), a prior art stack of readout integrated circuit chips and a prior art stack of readout integrated circuit chips with a photo-detector array to be bump bonded on the surface of the stack of chips.

FIG. 2a depicts a weak LIDAR echo return signal and a strong LIDAR echo return signal in a LIDAR system without a threshold.

FIG. 2b depicts a weak LIDAR echo return signal and a strong LIDAR echo return signal in a LIDAR system with a threshold and illustrating “range walk”.

FIG. 3 depicts a differentiated Gaussian echo return signal using the method of the invention and illustrating the original received Gaussian signal and resultant differentiated Gaussian signal for use as a zero-crossing or threshold detection means.

FIG. 4 is a schematic diagram of a preferred embodiment of a differentiating circuit electrically coupled to a threshold comparator circuit in a LIDAR system.

The invention and its various embodiments can now be better understood by turning to the following description and illustrations of the preferred embodiments which are presented as illustrated examples of the invention in any subsequent claims in any application claiming priority to this application. It is expressly understood that the invention as defined by such claims may be broader than the illustrated embodiments described below.

### DETAILED DESCRIPTION OF THE INVENTION

Turning now to the figures wherein like references define like elements among the several views, Applicant discloses a comparator circuit and predetermined threshold crossing detector method and circuit that may be used in, for instance, a LIDAR time-of-flight system having a long pulse laser.

Prior art LIDAR photo-detector sensor read out integrated circuits (or “ROICs”) used in LIDAR imaging circuitry are greatly constrained in functionality due to very small unit cell size. Active LIDAR sensor systems are currently designed with unit cells of 50 microns or less. Unit cell design philosophy is primarily dominated by area constraints. However, high density microelectronic integrated circuit (“IC”) chip stacking technology provides the ROIC designer freedom in unit cell design by offering in the range of up to one hundred times the unit cell design area provided under prior art, non-stacked LIDAR ROIC design considerations.

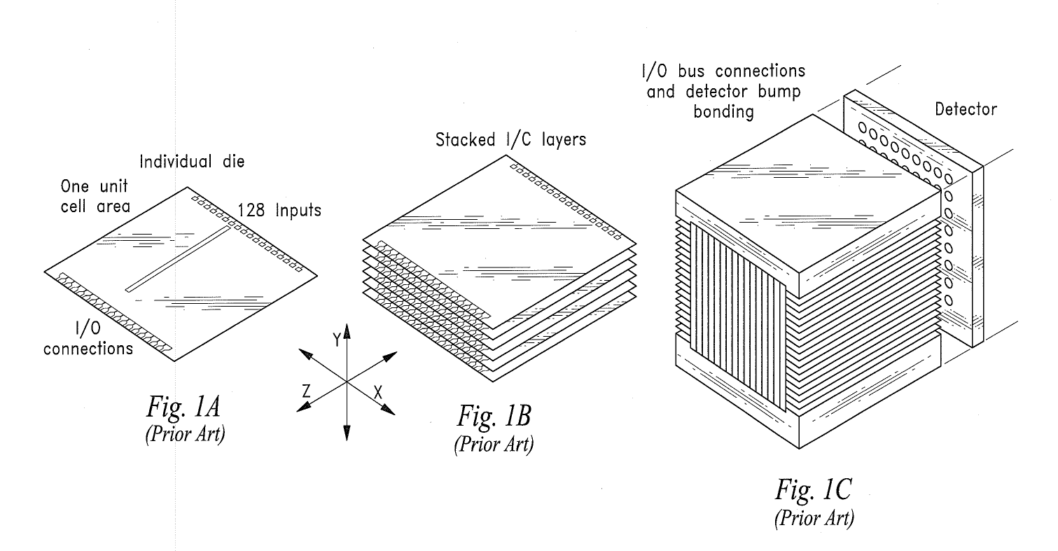

An exemplar prior art imaging module architecture incorporating the stacked IC chip technology referred to above is shown in FIGS. 1A, 1B and 1C and is disclosed in U.S. Pat. No. 7,436,494 entitled “Three-Dimensional LADAR Module With Alignment Reference Insert Circuitry” to Kennedy et al. and issued on Oct. 14, 2008.

FIG. 1A depicts an IC layer having one or more unit cells fabricated thereon and having I/O connections and detector inputs that define edge electrical connection points when the layers are stacked.

FIG. 1B depicts a plurality of prior art layers whereby the respective I/O connections and detector inputs are in vertical registration and alignment.

FIG. 1C depicts a prior art bonded stack of IC layers and a photo-detector element such as a focal plane array to be electrically connected using bump bonding to detector inputs using the edge connection points of the layers in the stack. The I/O connections may be interconnected or connected to external control circuitry using metalized “T-connect” structures defined on the lateral surfaces of the stack of layers using known photolithography and plating methods.

In the illustrated stacked architecture, a plurality of ICs in the stack of ICs contain photo-detector output signal processing unit cells for one row in the sensor's detector array of pixels. The number of pixel columns in the sensor's detector array determines the desired number of ICs in the stack.

The photo-detector array is conventionally bump-bonded (such as indium bump-bonding) after the IC stacking and interconnection processes are completed. Individual IC layers in the stack are preferably designed with at least the number of unit cell channels necessary to readout a single row of pixels in the detector array. The unit cell spacing may be based upon the detector pixel pitch in the X-axis but can be arbitrarily long in the Z-axis. The final size of the completed photo-detector imaging module of the invention is based on several stacking processing factors, but can be quite small.

It is understood in the LIDAR art that for LIDAR readout integrated circuits used for sensing time-of-flight laser echo signals reflected from a scene of interest, the ROIC timing circuitry and FIFO sampling rates in the ROIC are preferably matched to the LIDAR system's imaging laser pulse width.

LIDAR range resolution requirements generally call for the use of very fast pulse lasers, i.e. 500 pico-seconds to 1,500 psec. Unfortunately, laser imaging systems with the necessary 500-1,500 pico-seconds pulse widths tend to be very expensive and have relatively few commercial or industrial applications.

On the other hand, commercial lasers are significantly less expensive but undesirably have much longer pulse widths, i.e. 5,000 pico-seconds to 10,000 pico-seconds. An example of lower cost commercial laser having relatively long pulse widths is a laser manufactured by Kigre, Inc.; Model MK-81, a 1 Hz pulse rep-rate, 3mj, side-pumped laser that is eye-safe at 1534 nm and having a laser output pulse width of about 6,000 pico-seconds. It is low-cost, small and light but has an undesirably long pulse widths; making it unsuitable for most LIDAR time of flight applications.

LIDAR laser imaging system pulse width requirements in systems using longer pulse width lasers have two competing elements to deal with. On the one hand, if the analog and sampling electronics in the LIDAR ROIC are slowed down to match the longer pulse width of low-cost commercial lasers; the LIDAR sensor loses range resolution. On the other hand, if the ROIC sampling electronics bandwidth is kept high to accommodate the longer pulse width laser, the system encounters the undesirable effect of “range walk”.

Range walk in a LIDAR system results in large laser return signals yielding a closer measurement distance than weak signals reflected from objects at the same distance. This undesirable effect occurs because the ROIC comparator circuitry that detects the echo pulse relies on a predetermined circuit threshold level setting.

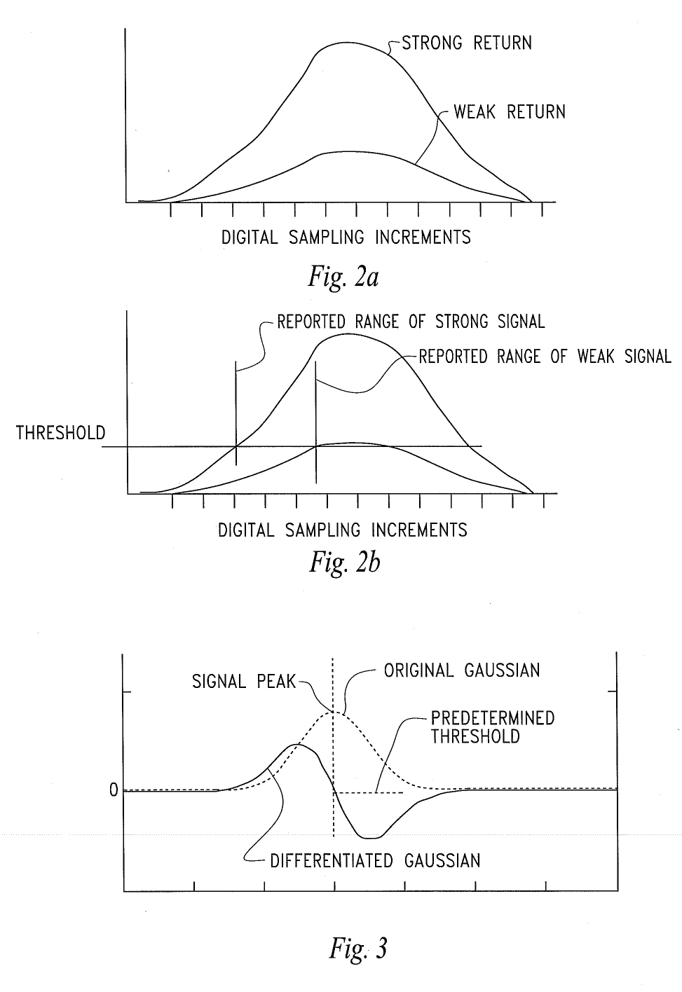

When the received laser echo in a prior art LIDAR system crosses the system's predetermined circuit threshold, an internal comparator circuit output changes state, indicating a laser return has been sensed. When using fast sampling on a slow laser pulse, the comparator can quite accurately determine when the comparator changes state. However, a large return signal and a small return signal in such a LIDAR system may cross the threshold over a span of many samples even when the pulse width is the same as illustrated in the waveform illustrations of FIGS. 2a and 2b.

System pre-processing of the laser echo using the differentiating circuit of the invention is provided to convert the laser echo return from a received Gaussian-like waveform into a differentiated waveform that crosses zero or other predetermined level at the exact time the original Gaussian has a peak amplitude as is illustrated in FIG. 3.

Using the method and circuit of the invention, regardless of the original Gaussian signal amplitude, the differentiated Gaussian always crosses the user-defined predetermined threshold level such as zero at the same time as the original Gaussian signal peak. Thus, when used as a threshold-detection or crossing comparator in a LIDAR system, i.e. as a comparator that changes state when a signal crosses zero or other predetermined threshold, the peak of the signal is precisely determined regardless of signal strength.

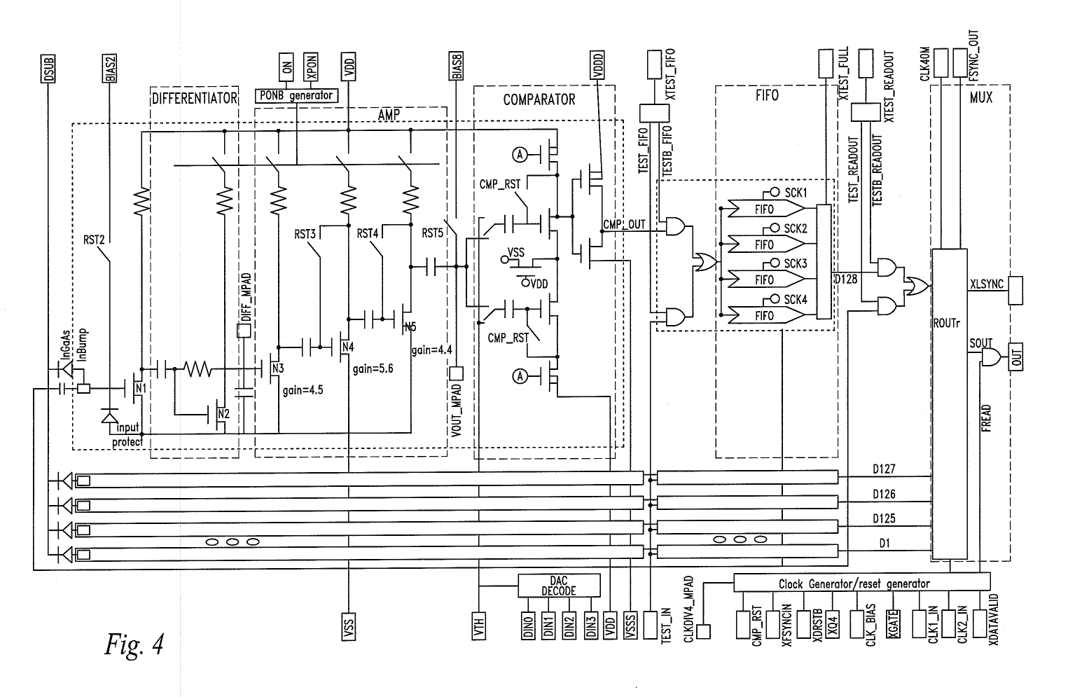

The return laser echo is preferably differentiated using high pass filter circuit means to convert the integrated Gaussian pulse into a Gaussian pulse. Suitable high pass filter signal differentiating means is illustrated in the circuit schematic diagram of FIG. 4 and may be used to perform the signal differentiation step.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the fact that the elements of such a claim may be set forth in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a subcombination or variation of a subcombination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

1. A method for determining the range of a target surface in a LIDAR system comprising the steps of:
imaging the target surface with an electromagnetic illumination signal,
receiving a reflected echo of the illumination signal as a return signal having a peak amplitude,
differentiating the return signal to define a differentiated signal having a signal level crossing point representative of the peak amplitude, and,
comparing the signal level crossing point to a predetermined threshold level to determine the range of the target surface.

2. The method of claim 1 wherein the return signal is a Gaussian signal.

3. The method of claim 1 wherein the return signal is differentiated using high pass filter circuitry means.

4. A LIDAR photo-detector module comprising:
a photo-detector array comprising a plurality of photo-detectors for detecting photons and generating output signals in response to photon detection,
a plurality of readout electronics integrated circuit chips,
each of the readout electronics integrated circuit chips comprising a plurality of channels for receiving and processing the output signals generated by the photo-detector array, wherein the plurality of readout electronics integrated circuit chips are arranged in a stacked configuration wherein said photo-detector array is bonded to a lateral surface of the stacked configuration perpendicular to the stacked configuration and connected to the plurality of channels via a plurality of connections arranged on the lateral surface of the stacked configuration, and,
wherein at least one of the readout integrated circuit chips comprises differentiating circuit means configured to output a differentiated signal having a signal level crossing point representative of the peak amplitude of a return signal.

5. The photo-detector module of claim 4 wherein the received signal is a Gaussian signal.

6. The photo-detector module of claim 4 wherein received signal is differentiated using high pass filter circuitry means.
